(19) United States
(12) Patent Application Publication
(10) Pub. No.: US 2017/0003503 A1
(43) Pub. Date: Jan. 5, 2017

(54) THERMOPLASTIC FILM FOR A LAMINATED-GLASS PANE HAVING A NON-LINEAR CONTINUOUS WEDGE INSERT IN THE VERTICAL DIRECTION IN SOME SECTIONS

(71) Applicant: SAINT-GOBAIN GLASS FRANCE, Courbevoie (FR)

(72) Inventors: Martin ARNDT, AACHEN (DE); Stefan GOSSEN, AACHEN (DE)

(21) Appl. No.: 15/039,794

(22) PCT Filed: Nov. 10, 2014
(86) PCT No.: PCT/EP2014/074116

§ 371 Date: May 26, 2016

(30) Foreign Application Priority Data
Dec. 12, 2013 (EP) 13196872.9

(51) Int. Cl. G02B 27/00; G02B 27/01; B32B 17/10

(52) U.S. Cl. CPC G02B 27/0018; B32B 17/10568; B32B 17/10036; B32B 17/10761; G02B 27/0101; B32B 2605/006

(57) ABSTRACT

A thermoplastic film for a laminated-glass pane having a non-linear continuous wedge insert in the vertical direction in some sections. The thermoplastic film has a continuous non-linear wedge angle profile having a first section, which has a wedge angle that is constant or that is variable at least in some sections in order to avoid double images in transmission. The nonlinear wedge angle profile also has a second section, which adjoins the first section. The second section has a variable wedge angle in order to avoid ghost images in reflection. The wedge angle profile has a third section, which adjoins the second section. The third section has a wedge angle that is constant or that is variable at least in some sections in order to avoid double images in transmission.

The invention relates to a thermoplastic film for a laminated glass pane having a nonlinear continuous wedge insert in the vertical direction in some sections.

### BACKGROUND OF THE INVENTION

Laminated glass panes are currently used in many places, in particular in vehicle construction. Here, the term “vehicle” is defined broadly and relates, among other things, to road vehicles, aircraft, ships, agricultural machinery, or even work implements.

Laminated glass panes are also used in other fields. These include, for example, building glazings and also information displays, e.g., in museums or as advertising displays.

In these cases, a laminated glass pane generally has two glass surfaces that are laminated onto an intermediate layer. The glass surfaces themselves can have a curvature and are usually of constant thickness. The intermediate layer usually has a thermoplastic material, usually polyvinyl butyral (PVB), of a predetermined thickness, e.g., 0.76 mm.

Since the laminated glass pane is generally inclined relative to an observer, double images occur. These double images are caused by the fact that incident light usually does not pass completely through both glass surfaces, but instead that at least part of the light is first reflected and only thereafter passes through the second glass surface.

These double images are perceptible in particular in the dark, in particular with strong irradiating light sources, such as the headlights of an oncoming vehicle.

These double images are extremely bothersome.

Frequently, the laminated glass pane is also used as a head-up display (HUD) for displaying data. Here, an image is projected on the laminated glass pane using a projection device to display information to the observer in the field of view. In the vehicle sector, the projection device is, for example, arranged on the dashboard such that the projected image is reflected in the direction of the observer on the nearest glass surface of the laminated glass pane inclined relative to the observer.

Again, however, part of the light enters the laminated glass pane and is now, for example, reflected on the inner boundary layer of the glass surface located farther out from the perspective of the observer and the intermediate layer and then exits the laminated glass pane with an offset.

Here, also, a similar effect, the ghost image effect, occurs relative to the image to be displayed.

This results in the fact that the respective observer is confused or, in the worst-case, receives incorrect information.

Previously, the attempt has been made to solve this problem by no longer arranging the surfaces of the glass surfaces parallel to each other but, instead, at a fixed angle. This is achieved, for example, in that the intermediate layer has a linearly increasing and/or decreasing thickness. In motor vehicle construction, the thickness is typically varied such that the smallest thickness is provided at the lower end of the pane toward the engine compartment, whereas the thickness increases linearly toward the roof. In other words, the intermediate layer has a wedge shape.

It has, however, been demonstrated that the prior art wedge-angle progressions can only inadequately minimize ghost images of head-up displays.

Based on this situation, one of the objects of the invention is to provide an improvement relative to double images and also ghost images.

### BRIEF DESCRIPTION OF THE INVENTION

The object is accomplished by a thermoplastic film for a laminated glass pane with a nonlinear continuous wedge insert in the vertical direction in some sections, wherein the laminated glass pane is farther from the observer in the vertical direction at a lower end from the perspective of an observer than at an upper end, wherein, in a laminated glass pane equipped therewith, the thermoplastic film is situated between two glass layers.

The term “wedge insert” refers to an insert, in particular a thermoplastic film, with a non-constant thickness. This is the term of art customary in the specific field. The wedge angle is the angle measured at a point between the surfaces of the insert. The wedge insert is nonlinear-continuously relative to the thickness. The wedge insert, that is to say the thermoplastic film, has a nonlinear continuous progression/change in thickness. A linear continuous change would correspond to a prior art constant wedge angle. A nonlinear continuous change results from a non-constant wedge-angle profile, wherein the wedge angle is position dependent. In that case, the wedge-angle profile can be linear or nonlinear. The term “in sections” means that the described progression applies to at least one section of the insert. In particular, the insert can have a plurality of sections which differ over the progression of the wedge-angle profile.

The thermoplastic film has, at least in some sections in the vertical direction, a continuous nonlinear wedge-angle profile, wherein the nonlinear wedge-angle profile has a first section that has, for preventing ghost images in transmission, a wedge angle that is constant or is variable at least in some sections, wherein the nonlinear wedge-angle profile further has a second section, which adjoins the first section, wherein the second section has, for preventing ghost images in reflection, a variable wedge angle, wherein the wedge angle from a lower end to an upper end is a function of the distance from the lower end or from the upper end, wherein the function is at least a second degree function, wherein the second section substantially minimizes ghost images of a head-up display, wherein the wedge-angle profile further has a third section, which adjoins the second section, wherein the third section has, for preventing ghost images in transmission, a wedge angle that is constant or is variable at least in some sections, wherein a wedge angle in the third section is substantially equal to or greater than the wedge angle at the lower end of the first section.

In one improvement of the invention, the thermoplastic film contains at least one material selected from the group comprising polybutylene terephthalate (PBT), polycarbonate (PC), polyethylene terephthalate (PET) and polyethylene naphthalate (PEN), polyvinyl chloride (PVC), polyvinyl fluorides (PVF), polyvinyl butyral (PVB), ethylene vinyl acetate (EVA), polyacrylate (PA), polymethyl methacrylate (PMMA), polyurethane (PUR), and/or mixtures and copolymers thereof.

According to yet another improvement of the invention, in the vertical direction, the wedge angle at the lower edge is smaller than the wedge angle at the upper edge.

In yet another embodiment of the invention, a transition region is provided between the first section and the second section, in which the wedge angle is transformed smoothly according to the requirements for the first section and the second section.

According to yet another improvement of the invention, a transition region is provided between the second section and the third section, in which the wedge angle is transformed smoothly according to the requirements for the second section and the third section.

In another embodiment of the thermoplastic film, in the second section A₂ the requirements for optimization of the wedge angle relative to double images in transmission and ghost images in reflection are determined by forming an approximation. Different approaches for compensation models can be used.

According to yet another embodiment of the invention, the variable wedge-angle progression in the second section reduces both ghost images in reflection and double images in transmission, wherein the wedge-angle progression in the second section deviates only less than 0.35 mrad, preferably less than 0.25 mrad, more preferably 0.15 mrad, particularly preferably 0.1 mrad, from a wedge-angle progression optimized for preventing ghost images in transmission.

In yet another embodiment of the invention, in a transition region between the first section A₁ and the second section A₂ and/or the second section A₂ and the third section A₂, the wedge-angle progression is such that the wedge angle deviates less than 0.2 mrad, preferably 0.15 mrad, particularly preferably 0.1 mrad, from a wedge-angle progression optimized for preventing ghost images in transmission.

According to yet another embodiment of the invention, the thermoplastic film F has, at the lower edge, a thickness of less than 1 mm, preferably less than 0.9 mm, and preferably a thickness of more than 0.3 mm, in particular more than 0.6 mm, at the lower end.

In one embodiment of the invention, the thermoplastic film has a noise-reducing effect. By this means, the transmission of noises through a laminated pane provided with the film can advantageously be reduced, as a result of which disturbance due to environmental noises and driving noises can be reduced. Such an effect can be obtained by means of a multilayer, for example, three-layer, thermoplastic film, wherein the inner layer has greater plasticity or elasticity than the outer layers surrounding it, for example, as a result of a higher content of softening agents.

In one embodiment of the invention, the thermoplastic film can have at least one tinted zone. Such a tinted zone on the upper edge of the pane is known to the person skilled in the art as a “shaded band”—by this means, disturbance of the driver by blinding sunlight can be reduced.

The thermoplastic intermediate layer can have, in one embodiment of the invention, a sun or heat protection function. For example, the thermoplastic intermediate layer can contain a reflective coating in the infrared range or IR-absorbing additives. The coating or additives can be arranged on or in the thermoplastic film with a wedge angle according to the invention. Alternatively, an additional thermoplastic film, for example, a coated PET film can be introduced into the thermoplastic intermediate layer.

In one embodiment of the laminated pane according to the invention, the first or the second glass pane can have a functional coating, preferably on its surface facing the thermoplastic film. Such functional coatings are familiar to the person skilled in the art, for example, electrically conductive coatings, heatable coatings, IR-reflective coatings, low emissivity coatings, antireflective coating, coloring coatings.

In one embodiment, the laminated pane according to the invention has a heating function. The heating function can affect the entire pane surface or only parts thereof. Such heating functions can, for example, be realized by means of wires embedded in the thermoplastic intermediate layer or by means of an electrically conductive coating on one of the glass panes or on a film of the intermediate layer. The invention further proposes a laminated glass pane with a thermoplastic film according to the invention as well as corresponding production methods for the thermoplastic film or the laminated glass pane as well as a head-up display arrangement and the use of a thermoplastic film and laminated glass panes equipped therewith.

The thermoplastic film according to the invention with variable thickness can be a film with noise-reducing effect (a so-called “acoustic film”). Such films are typically composed of at least three layers, wherein the middle layer has higher plasticity or elasticity than the outer layers surrounding it, for example, as a result of a higher softening agent content.

The laminated glass pane can contain, in addition to the thermoplastic film according to the invention, a tinted insert. Such inserts are typically arranged in the upper region of the laminated glass pane/windshield and are intended to reduce the disturbing or blinding of the driver by sunlight. They are commonly referred to as a “shaded band”.

The laminated glass pane can have a functional coating, for example, an IR reflecting or absorbing coating, a UV reflecting or absorbing coating, a low emissivity coating, a heatable coating. The functional coating is preferably applied on one of the surfaces facing the wedge insert, where it is protected against corrosion and damage.

The laminated glass pane can also contain an insert film with a functional coating between the glass panes, for example, made of polyethylene terephthalate (PET). Such coated PET films, for example, with IR reflecting coatings are commercially available and can thus be easily introduced into laminated glass.

### BRIEF DESCRIPTION OF THE DRAWINGS

Embodiments of the present invention are described by way of example with reference to the appended drawings, which depict:

FIG. 1 the basic context of the development of double images in transmission,

FIG. 2 the basic context of the development of ghost images in reflection,

FIG. 3 an exemplary structure of a laminated glass pane with a wedge-shaped interlayer,

FIG. 4 an exemplary wedge-angle profile for compensation of double images in transmission,

FIG. 5 an exemplary arrangement that demonstrates the relationship of different eye positions relative to a HUD display.

FIG. 6 wedge-angle values determined as examples for different vertices of an HUD region that correspond to different eye positions,

FIG. 7 an exemplary wedge-angle profile for compensation of ghost images in reflection,

FIG. 8 a combined view of an exemplary wedge-angle profile for compensation of double images in transmission in individual sections and for compensation of ghost images in reflection in another section.

FIG. 9 a combined view as in FIG. 8, wherein the wedge-angle profile for compensation of double images in transmission is replaced in individual sections by an approximation curve,

FIG. 10 a combined view as in FIG. 9, wherein, additionally, in the section for compensation of ghost images in reflection, the compensation of double images in transmission is taken into account,

FIG. 11 a combined view as in FIG. 8, wherein the section for compensation of double images in transmission has transition regions for adaptation to the wedge-angle profile for compensation of ghost images in reflection,

FIG. 12 an exemplary distribution of double image angles on a laminated glass pane, and

FIG. 13 an exemplary distribution of the distance of the ghost image from the desired HUD image on a HUD region of a laminated glass pane.

### DETAILED DESCRIPTION OF THE INVENTION WITH REFERENCE TO THE DRAWINGS

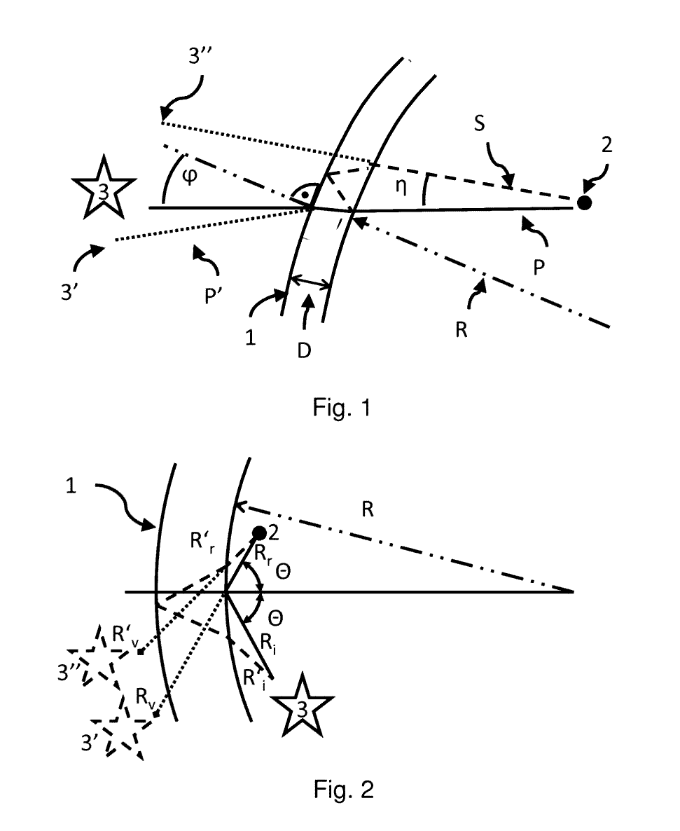

FIG. 1 depicts the basic context of the development of double images in transmission using a beam image. A curved pane 1 is assumed. The curved pane has, at the point of entry of the beam into the curved glass pane 1, a radius of curvature (R+D). Light is now emitted from the light source 3. This light strikes the pane and is refracted in accordance with known refraction laws at the transition from air to glass on the first boundary and from glass to air on the second boundary and reaches the eye 2 of an observer. This beam is depicted as the solid line P. From the perspective of the observer, the light source 3 appears to be situated at the location 3′. This is depicted as beam P′. However, in addition to this beam P referenced as the primary beam, the beam is only partially refracted on the second gas/air boundary in the manner described above; a smaller fraction is reflected on the second boundary and is once again reflected on the first boundary before the beam now passes through the second boundary and reaches the eye 2 of the observer. This beam, the so-called “secondary beam” is depicted as a dashed line S. From the perspective of the observer, the light source 3 also appears to be situated at the location 3″. The angle η enclosed by the primary beam P′ and the secondary beam S is the so-called “double image angle”.

In order to address this double image, provision can now be made that a wedge angle be provided between the two boundary layers assumed to be substantially parallel in FIG. 1.

According to J. P. Aclocque “Doppelbilder als störender optischer Fehler der Windschutzscheibe [Double Images As Interfering Optical Errors in Windshields]” in Z. Glastechn. Ber. 193 (1970) pp. 193-198, the double image angle can be calculated as a function of the radius of curvature of the glass pane and the angle of incidence of the light beam according to the following equation:

$$η = \frac{2 d}{R} \cdot \frac{sin ϕ}{\sqrt{{n}^{2} - {sin}^{2} ϕ}} ,$$

where
η is the double image angle, n is the index of refraction of the glass, d is the thickness of the glass pane, R is the radius of curvature of the glass pane at the location of the incident light beam, and φ is the angle of incidence of the light beam relative to the perpendicular on the tangent to the pane.

In the case of flat glass panes, the double image angle η is, according to the following formula,

$$η = 2 \cdot δ \cdot \frac{\sqrt{{n}^{2} - {sin}^{2} ϕ}}{cos ϕ}$$

a function of the wedge angle δ formed by the glass surfaces.

Thus, by setting the aforementioned formulas equal, the wedge angle necessary for the elimination of the double image can be calculated:

$$δ = \frac{d}{R} \cdot \frac{cos ϕ \cdot sin ϕ}{{n}^{2} - {sin}^{2} ϕ} .$$

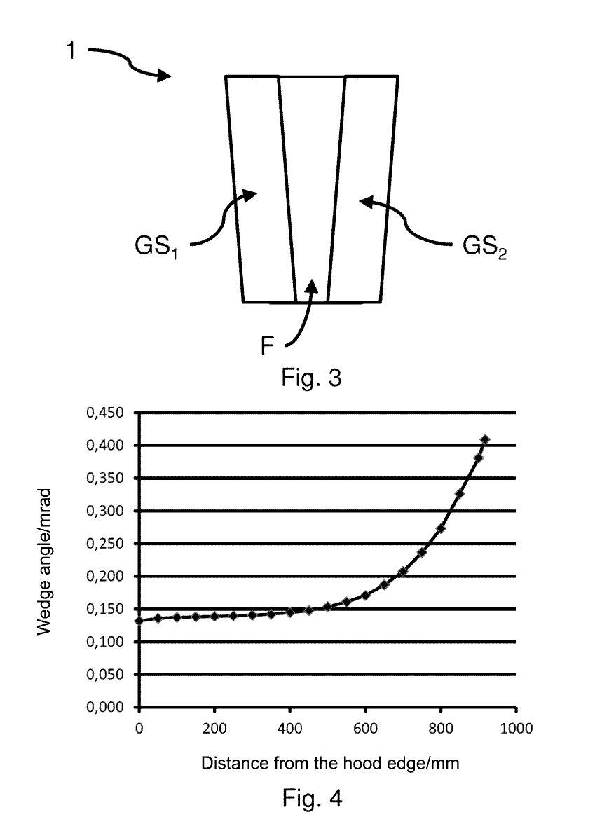

Generally, this wedge angle is realized in that in laminated glass panes 1 a wedge-shaped intermediate layer F is placed between a first glass layer GS₁ and a second glass layer GS₂, see FIG. 3. It can generally be assumed for the sake of simplicity that the index of refraction n is constant, since the difference in the index of refraction of the intermediate layer F and the glass panes GS₁, GS₂ is rather small such that there is hardly any effect due to the small difference.

This idea can be also applied with curved windshields. Generally, for the sake of simplicity the angle of incidence and the radius of curvature are assumed for a reference eye point, and the wedge angle determined therewith is used for the entire windshield.

In the case of large laminated glass panes 1, so-called “panorama panes”, and/or more highly curved laminated glass panes 1, this approach is, however, no longer adequate such that here, generally, a wedge-angle progression variable in the vertical direction must be determined.

Then, it is possible, for example, by pointwise calculation along an imaginary vertical center line of a laminated glass pane and possible interpolation, to determine a compensation wedge-angle profile δ.

For the calculation of the double image angle η and the corresponding local compensation wedge angle δ, the arrangement as recommended in the Test Specification ECE R43 Annex 3 for determining the double image angle can be selected. With this arrangement, the double image angles are determined when the head of the driver moves from a lower position in the vertical direction to an upper end position. In other words, the drivers line of sight always remains horizontal. However, alternatively or additionally, an arrangement can be selected in which the double image angle is calculated from a mean unchanging position of the driver (eye point), where the angle of sight of the driver through the windshield changes. The result of different determination variants can be transformed, even with weighting, into an overall result.

An exemplary wedge-angle profile, i.e., a progression of the wedge angle as a function of the distance from the hood edge, i.e., to the lower end of a laminated glass pane 1, is shown in FIG. 4. It is clearly discernible that a wedge angle δ for an imaginary virtual center line optimized according to the above formulas begins, in the exemplary windshield, at the lower end initially with values of less than 0.15 mrad and with increasing distance from the hood edge, i.e., toward the upper end of the laminated glass pane 1, increases to values of more than 0.4 mrad.

In an exemplary method, the wedge angle required for compensation of the double image is calculated mathematically as a function of the local angle of incidence and a local radius of curvature of the laminated glass pane 1, and the resultant progression of the double image angle η is determined. By way of example, a possible result of double image angles η is shown in FIG. 12 for a laminated glass pane 1 of a motor vehicle. Here, an exemplary laminated glass pane 1 is mapped onto an xy coordinate system, wherein the horizontal axis indicates a distance relative to the center of the laminated glass pane 1 and the vertical axis indicates a distance relative to a lower plane (not shown). It should be noted that the representation of the pane does not necessarily correspond to its actual installation, but is depicted in the figure such that the greatest possible projection surface is present. The resultant double image angle is reported in arcminutes.

With regard to head-up displays, a problem develops which is similar to the phenomenon of double images and is referred to as a ghost image.

FIG. 2 presents the basic context of the development of ghost images in reflection with reference to a beam image. Here, a curved glass pane 1 is assumed. The curved glass pane 1 has a radius of curvature R at the location of the entry of a beam into the curved glass pane 1. Light is now emitted from the light source 3, which is representative of a head-up display HUD. This light impinges on the glass pane 1 along the beam Rᵢ from the inside at an angle θ and is reflected there at the same angle θ. The reflected beam Rᵣ reaches the eye 2 of an observer. This beam path is depicted as a solid line. From the perspective of the observer, the light source 3 appears to be situated virtually at the location 3, i.e., in front of the glass pane 1. This is depicted as beam Rᵥ. In addition to this first beam, another beam reaches the eye 2 of the observer. This beam R′ᵢ likewise originates from the light source 3. However, this beam R′ᵢ penetrates, in accordance to the known laws of refraction, into the glass pane 1 on the inner air/glass boundary surface and is reflected on the outer glass/air boundary surface before the beam passes through the inner boundary surface and reaches the eye 2 of the observer as beam R′ᵣ. The term “inner boundary surface” thus refers to the boundary surface that is situated closer to the observer, whereas the term “outer boundary surface” refers to the boundary surface that is farther away from the observer. This beam path is depicted as a dashed line. From the perspective of the observer, the light source 3 appears to be situated virtually at the location 3″, i.e., likewise in front of the glass pane 1. This is depicted as beam R′ᵥ.

To address this problem, the wedge angle can now be altered such that the beam R′ᵣ reflected on the outer boundary surface and the beam Rᵣ reflected on the inner boundary surface overlap relative to the eye 2 of the observer, i.e., the beam reflected on the outer boundary surface exits at the point of reflection of the beam impinging on the inner boundary surface.

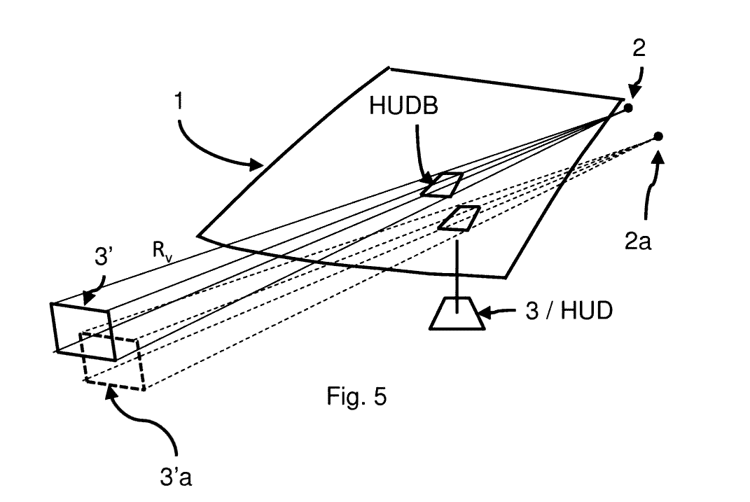

However, if this is done only for a single eye position, as is customary according to the prior art, the wedge angle determined therefrom can yield non-optimum results. This can be explained, among other things, by the fact that both the body sizes of drivers for whom the HUD displays are primarily intended and the seating position are very different such that there are a large number of possible eye positions. This is illustrated in FIG. 5. There, two possible eye positions 2 and 2a are depicted on the right side of FIG. 5. The position of the image 3′ or 3′a results as a function of the eye position 2 or 2a. Even the region of the pane in the head-up display region HUDB (“active region”) involved in the optical process for image generation is a function of the eye position 2, 2a. As a model, the projector image 3 and virtual image 3′, 3′a can be construed as full area rectangles. The connecting lines from the eye position 2, 2a to the corners of the rectangles are drawn in in the figure. The intersections of these connecting lines with the pane yield the corners of a trapezoid which, by way of a model, should describe the “active region” of the pane. These trapezoids are depicted, by way of example, inside the head-up display region HUDB on the glass pane 1 in the figure. Thus, the virtual display is situated in different places depending on the eye position and, accordingly, there is, for each of these eye positions, possibly a different value for an optimized wedge angle. In addition, it should be mentioned here that a wedge angle optimized exclusively for ghost images usually results in overcompensation of double images such that the double images thus caused are again problematic relative to the perception of the observer and/or compliance with regulatory test specifications and/or compliance with customer specifications relative to double images.

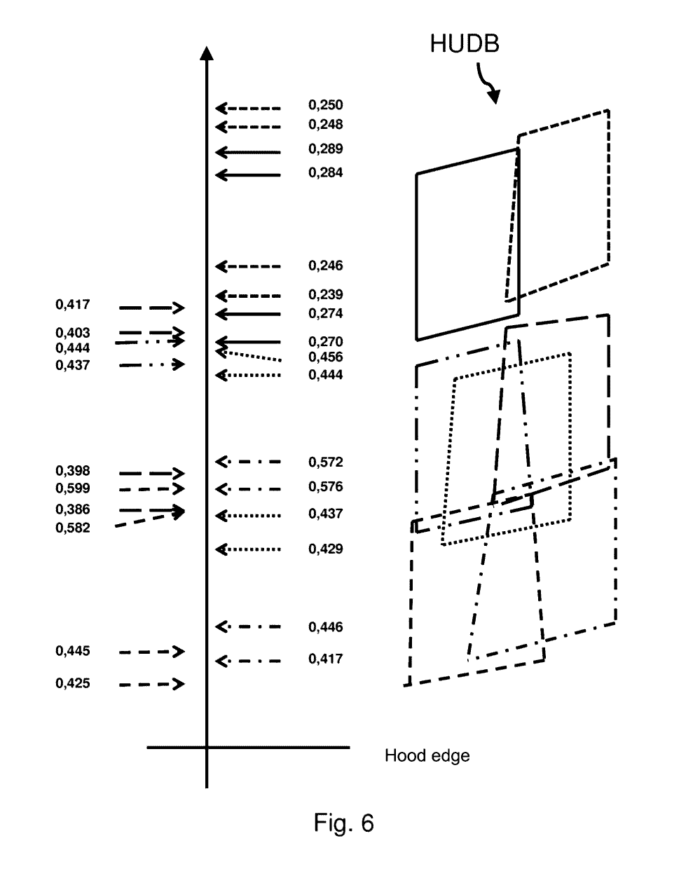

FIG. 6 reports the resultant positions of an HUD in the form of the above-described trapezoid (as “active” regions) within a head-up display region HUDB for different positions of the eye 2 relative to the laminated glass pane 1. For better differentiation, the trapezoids are presented with different types of lines. For clarity, the associated wedge angles determined for a number of trapezoids are indicated relative to the corners of the trapezoids and entered on the left side relative to the distance from the hood edge.

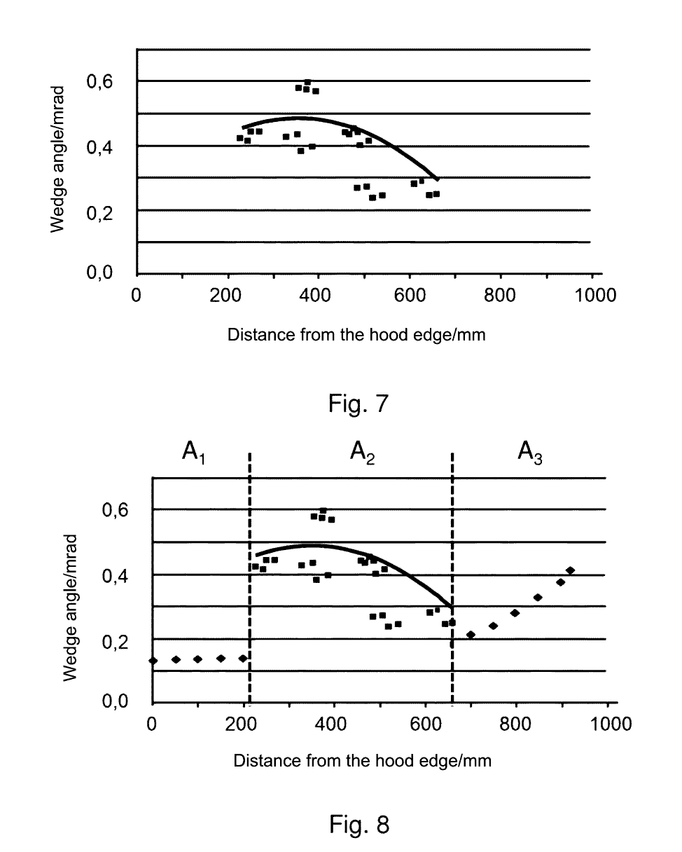

For better visualization, these values are also depicted in FIG. 7 as wedge angles relative to the distance from the hood edge, i.e., the lower end of the laminated glass pane 1. Individual values determined are marked as a square.

From these values, an approximation curve, which is depicted in FIG. 7 by way of example as a solid line, can now be determined. This approximation curve can be of the first order but also of a higher order.

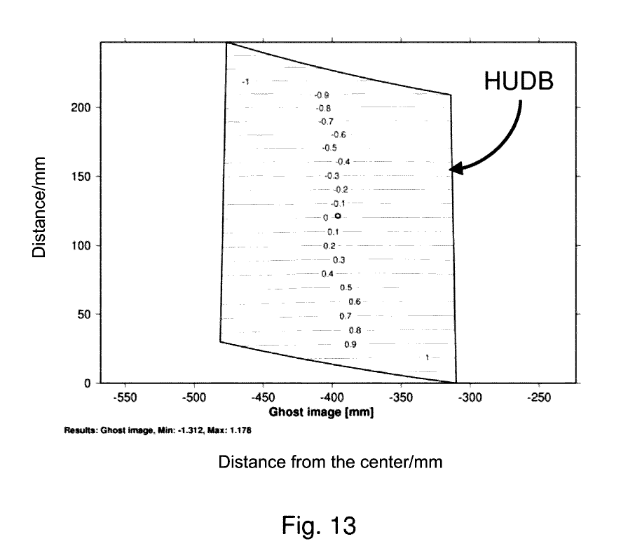

In an exemplary method, the wedge angle required for compensation of the double image is calculated as a function of the local angle of incidence and a local radius of curvature of the laminated glass pane 1, and the resultant progression of the wedge angle is determined. By way of example, a possible result of perceived location-shifted ghost images is depicted in FIG. 13 for a head-up display region HUDB of a laminated glass pane 1 of a motor vehicle. This head-up display region HUDB corresponds to the detail HUDB in FIG. 12. In this respect, the horizontal axis again refers to a distance relative to the center of the laminated glass pane 1. Here, however, the vertical axis relates to the deepest point of the head-up display region HUDB. The figure now shows the distance between a primary beam and a secondary beam in mm.

However, for many areas of application, both a minimization of double images and also of ghost images is desirable.

To achieve this, the invention proposes a thermoplastic film F for a laminated glass pane 1 with, in some sections in the vertical direction, a nonlinear continuous wedge-angle insert.

Typically, e.g., in motor vehicle construction, the laminated glass pane 1 is farther from the observer in the vertical direction at a lower end from the perspective of an observer than at an upper end.

As previously described with reference to FIG. 3, in a laminated glass pane 1 equipped therewith, the thermoplastic film F according to the invention is situated between two glass layers GS₁, GS₂.

The thermoplastic film F, as is depicted in the following with reference to FIG. 7 through 9, can be divided into three sections A₁, A₂, A₃.

In this case, the thermoplastic film F has, in the vertical direction at least in some sections, a continuous nonlinear wedge-angle profile.

In a first section A₁, the wedge-angle profile is designed such that double images in transmission are prevented. Corresponding to FIG. 3, the wedge-angle profile has, with increasing distance from the lower end, i.e., with use in a laminated glass pane 1 for a motor vehicle, from the hood edge, a wedge-angle that is constant or is variable at least in some sections.

In a second section A₂, which adjoins the first section A₁, the wedge-angle profile is designed such that ghost images in reflection are prevented. Corresponding to FIG. 5, the wedge-angle profile has a variable wedge-angle, wherein the wedge angle is, from a lower end to an upper end, a function of the distance from the lower end or from the upper end, wherein the function is a function of at least the second degree. Here, this second section A₂ is designed such that it substantially minimizes ghost images of a head-up display HUD.

In a third section A₃, which adjoins the second section A₂, the wedge-angle profile is designed such that, again, ghost images in transmission are prevented. Corresponding to FIG. 3, the wedge-angle profile has, with increasing distance from the lower end, i.e., with use in a laminated glass pane 1 for a motor vehicle from the hood edge, a wedge angle that is constant or that is variable at least in some sections. A wedge angle in the third section A₃ is substantially equal to or greater than the wedge angle at the lower end of the first section A₁.

In principle, a wedge-angle profile as depicted in FIG. 8 would be desirable, since, since with it, in the first section A₁ and in the last section A₃, the wedge angle would be optimally selected for compensation of double images for an exemplary laminated glass pane 1, whereas in the section A₂ the wedge angle would be optimized for a number of eye positions for compensation of ghost images for an exemplary laminated glass pane 1.

With the possible configuration that the wedge-angle profile in the first section A₁ and/or the third section A₃ has, substantially, a constant wedge angle, a satisfactory result can still be obtained from the standpoint of favorable production costs with only slight deviations from an ideal value. Such an example is depicted in FIG. 9, wherein, in the first section A₁ and in the third section A₃, a constant wedge angle corresponding to the dash-dot lines is assumed. In this process, other parameters, such as a maximum wedge angle or a maximum wedge-angle change, can also be taken into account. Such parameters can, for example, result from the fact that a change in the thickness of the laminated glass pane 1 must not exceed a maximum value. Thus, provision can, for example, be made that a certain “overcompensation” takes place in the first section, i.e., the wedge angle is larger than the ideal wedge angle, whereas in the third section, the wedge angle is smaller than the ideal wedge angle such that a certain “undercompensation” occurs.

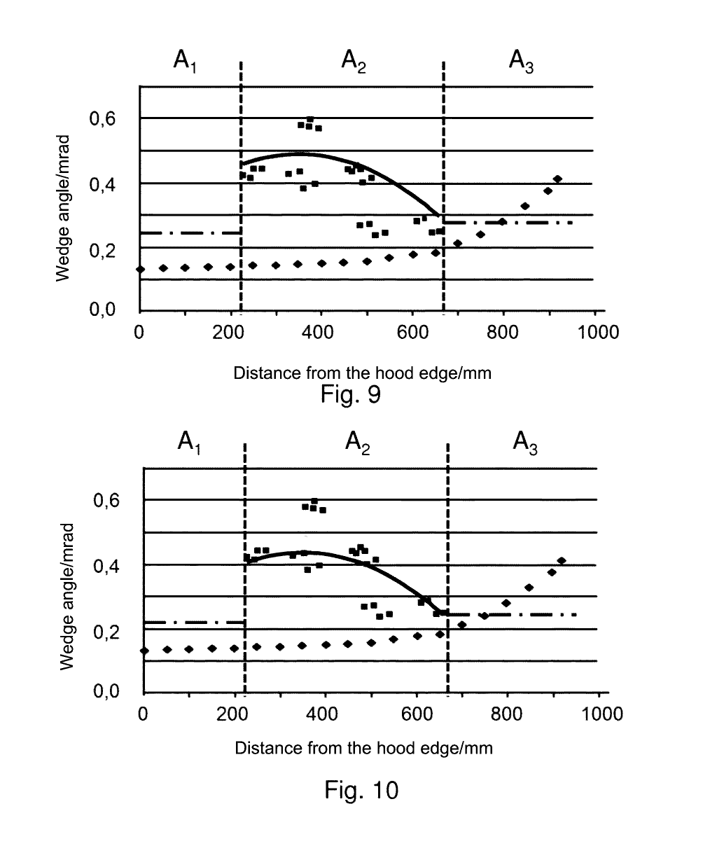

In the second section, optimization relative to minimization of double images is substantially provided. In this case, (over)compensation of double images in transmission also usually occurs. In this second section, provision can be made, depending on requirements, that the compensation of ghost images is only executed sub-optimally in favor of less overcompensation of double images. This is, for example, depicted in FIG. 10. Here, an average can be formed in a conventional manner or any other form of weighting can be provided either as a function of the location or even over the entire section A₂.

In principle, it is also possible to use a linear wedge-angle progression in the second section A₂.

The transition of the wedge-angle progression between the first and the second section is, for the sake of simplicity, depicted stepwise in FIGS. 9 and 10. In reality, the transition usually has, advantageously, a continuous progression.

However, a wedge-angle progression wherein the wedge angle is a function of second or higher order, as indicated in FIG. 7 through 11, is of particular advantage. In this case, the transitions from the first section into the second section and also from the second section into the third section are designed such that there are only small jumps in the slope. This has a positive effect on the dynamics of the interfering images. Here, the term “dynamics” means that ghost images suddenly appear stronger due to movement of the head and a resultant different position of the eye 2. This occurs more, the more the wedge angle changes with improper compensation of the wedge angle.

In an exemplary method, the wedge angle is determined relative to different eye positions and the function of the wedge-angle progression is determined as a curve fit on the wedge angle determined therefrom.

Such a thermoplastic film F can contain at least one material selected from the group comprising polybutylene terephthalate (PBT), polycarbonate (PC), polyethylene terephthalate (PET) and polyethylene naphthalate (PEN), polyvinyl chloride (PVC), polyvinyl fluorides (PVF), polyvinyl butyral (PVB), ethylene vinyl acetate (EVA), polyacrylate (PA), polymethyl methacrylate (PMMA), polyurethane (PUR), and/or mixtures and copolymers thereof.

The selection of a suitable material for the thermoplastic film F can, for example, depend on the properties of the film with regard to the refractive index and also the strength achievable with regard to a certain film thickness. In principle, the invention is not restricted to a specific material for a thermoplastic film F.

In order to minimize double images, in the laminated glass panes 1 generally installed at an angle in vehicle construction, a wedge-angle profile is preferred, wherein, in the vertical direction, the wedge angle at the lower edge is smaller than the wedge angle at the upper edge, i.e., the wedge angle in the vicinity of the vehicle hood is smaller than the wedge angle in the vicinity of the roof edge of a typical motor vehicle.

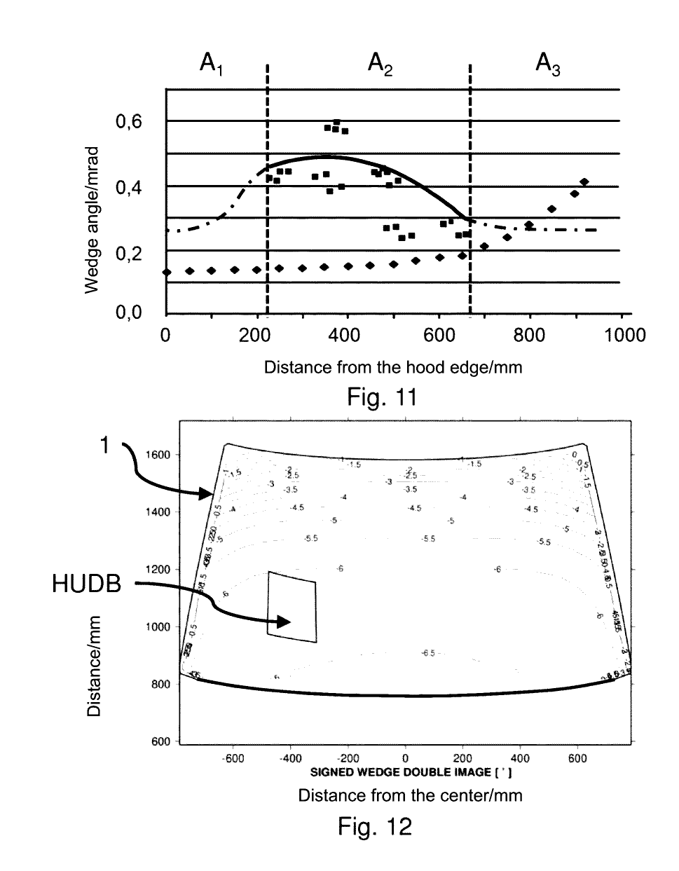

It is particularly advantageous when a transition region as depicted in FIG. 11 is provided between the first section A₁ and the second section A₂, in which region the wedge angle corresponding to the requirements of the first section A₁ and of the second section A₂ are smoothly transformed into each other. It is equally advantageous when a transition region as depicted in FIG. 11 is provided between the second section A₂ and the third section A₃, in which region the wedge angle corresponding to the requirements of the second section A₂ and the third section A₃ are smoothly transformed into each other. By this means, abrupt changes of the wedge angle and also of the wedge-angle slope are prevented such that the transition between the individual regions is perceived by the observer as fluid. In addition, a smoother transition can also be suitable to prevent possible stresses in the laminated glass panes.

As described above, the progression of the wedge-angle profile in the entire second section A₂ can be understood as an average between a reflection-optimized value and a transmission-optimized value, in order to minimize both double images and ghost images. Here, greater weighting of the ghost image compensation still enables adequate double image compensation.

In order to be able to take different eye positions into account, optimization relative to ghost images is done with an increasing number of specific wedge angles for specific eye positions. From the values determined, it is possible, for example, as depicted in FIGS. 7 to 11, to approximate a wedge-angle profile as a function of second or higher order. Here, the values determined can also be adopted for optimization relative to double images and, thus, an approximation curve can be determined for the second section A₂ and/or also the section A₁ and/or also the section A₃.

Provision can also be made in embodiments of the invention that the wedge-angle progression in the second section deviates only less than 0.35 mrad, preferably less than 0.25 mrad, more preferably 0.15 mrad, particularly preferably 0.1 mrad, from a wedge-angle progression optimized to prevent ghost images in transmission.

Provision can also be made in embodiments of the invention that, in a transition region between the first section A₁ and the second section A₂ and/or the second section A₂ and the third section A₃, the wedge-angle progression is such that the wedge angle deviates less than 0.2 mrad, preferably 0.15 mrad, particularly preferably 0.1 mrad, from a wedge-angle progression optimized to prevent ghost images in transmission.

For example, in FIG. 11 in the section A₁ and in the section A₃ the wedge-angle progression is approximated such that a wedge-angle difference of approximately 0.15 mrad is maintained. Also, in the section A₂ the wedge-angle progression is selected such that a wedge-angle difference of less than 0.2 mrad downward (i.e., approximately 0.5 mrad instead of 0.5 mrad at a 400 mm distance from the lower edge).

By this means, a determined deviation empirically perceived as non-interfering can be taken into account in the design of a wedge-angle profile such that the production costs can be optimized.

For manufacture, it is particularly advantageous for the thermoplastic film F according to the invention to have, at the lower edge, a thickness of less than 1 mm, preferably less than 0.9 mm, and preferably a thickness of more than 0.3 mm, in particular more than 0.6 mm. As a result, the film can be used in a proven manner in the production of laminated glass panes 1, without the need for cost-driving special equipment.

Thus, a structure of a laminated glass pane 1, as shown in FIG. 3, can be obtained even with the thermoplastic film F according to the invention between a first glass layer GS₁ and a second glass layer GS₂.

Such laminated glass panes 1 have a thickness of 1 mm to 8 mm, preferably 3.5 to 5.3 mm, and can thus readily be further processed like conventional laminated glass panes.

Here, the first glass layer GS₁ and/or the second glass layer GS₂ of the laminated glass pane 1 typically have a thickness selected from a range of roughly 1 mm to 3 mm, in particular of 1.4 mm to 2.6 mm auf, for example, 2.1 mm. This guarantees the required properties of splinter protection and/or sound insulation.

With the thermoplastic film F, a laminated glass pane 1 can thus be produced in a proven manner, in that a first glass layer GS₁ and a second glass layer GS₂ are obtained, wherein the thermoplastic film F is placed on the first glass layer GS₁, and the second glass layer GS2 is placed on thermoplastic film with the use of an autoclave process. Thereafter, the thermoplastic film F is bonded to the first glass layer GS₁ and the second glass layer GS₂ in the autoclave under the action of heat and pressure.

Of course, the thermoplastic film F according to the invention can be used not only in an autoclave process but can, for example, also be used with a vacuum thermal furnace process or similar autoclave-free processes.

It is also, in principle, possible to initially bond only a first glass layer GS_{A} to the thermoplastic film F after placement and only after that to place the second glass layer GS₂ and to bond it to the thermoplastic film F previously bonded to the glass layer GS₁.

Thermoplastic films F thus produced can be used in laminated glass panes 1 in motor vehicles, in particular as windshields for display of a head-up display, or in buildings or as data displays.

Use in a head-up display arrangement can be seen, for example, in FIG. 5. There, a projector as a light source illuminates an exemplary head-up display region HUDB of a laminated glass pane 1, which is equipped with a thermoplastic film F according to the invention. Ghost images of the projector are minimized in the head-up display region HUDB, whereas the entire laminated glass pane 1 also reduces double images in transmission (not shown).

Although in the figures in general only a head-up display region HUDB is depicted, the invention is not restricted thereto. For example, even more head-up display regions HUDB, e.g., for right-hand and left-hand vehicles or even for different purposes, such as an infotainment system and driver assistance systems can be provided. Provision can also be made that, for example, in the case of head-up display regions HUDB that are used substantially in infotainment, only minimization of ghost images is provided, whereas with driver assistance systems minimization of both ghost images and double images is sought. As a result, the invention enables improvement with regard to minimization of ghost images of head-up displays for a large number of eye positions without generating substantially more ghost images outside the head-up display region HUDB. Furthermore, by means of the invention, it can also be accomplished that in the head-up display region HUDB as well as in the other regions, double images in transmission are reduced. In addition, larger head-up display regions HUDB as well as more complex windshield curve designs can be realized with the invention presented.

1.-19. (canceled)

20. A thermoplastic film for a laminated glass pane with a nonlinear continuous wedge insert in the vertical direction, wherein the laminated glass pane is farther from the observer in the vertical direction at a lower end from the perspective of an observer than at an upper end, wherein, in a laminated glass pane equipped therewith, the thermoplastic film is situated between two glass layers,
wherein the thermoplastic film has, in the vertical direction at least in some sections, a continuous nonlinear wedge-angle profile,
wherein the nonlinear wedge-angle profile has a first section, which has, for preventing double images in transmission, a wedge angle that is constant or is variable at least in some sections,
wherein the nonlinear wedge-angle profile further has a second section, which adjoins the first section, wherein the second section has, for preventing ghost images in reflection, a variable wedge angle, wherein the wedge angle from a lower end to an upper end is a function of the distance from the lower end or from the upper end, wherein the function is at least a second degree function, wherein the second section substantially minimizes ghost images of a head-up display,
wherein the wedge-angle profile has a third section, which adjoins the second section, wherein the third section has, for preventing double images in transmission, a wedge angle that is constant or is variable at least in some sections, wherein a wedge angle in the third section is substantially equal to or greater than the wedge angle at the lower end of the first section.

21. The thermoplastic film according to claim 20, wherein the thermoplastic film contains at least one material comprising polybutylene terephthalate (PBT), polycarbonate (PC), polyethylene terephthalate (PET) and polyethylene naphthalate (PEN), polyvinyl chloride (PVC), polyvinyl fluorides (PVF), polyvinyl butyral (PVB), ethylene vinyl acetate (EVA), polyacrylate (PA), polymethyl methacrylate (PMMA), polyurethane (PUR), and mixtures and copolymers thereof.

22. The thermoplastic film according to claim 20, wherein, in the vertical direction, the wedge angle at the lower edge is smaller than the wedge angle at the upper edge.

23. The thermoplastic film according to claim 20, wherein, between the first section and the second section, a transition region is provided, in which the wedge angle is smoothly transformed according to the requirements of the first section and of the second section.

24. The thermoplastic film according to claim 20, wherein, between the second section and the third section, a transition region is provided, in which the wedge-angle is smoothly transformed according to the requirements of the second section and of the third section.

25. The thermoplastic film according to claim 20, wherein, in the second section, the requirements for optimization of the wedge angle relative to double images in transmission and ghost images in reflection are determined by forming an approximation.

26. The thermoplastic film according to claim 20, wherein the variable wedge-angle progression in the second section reduces both ghost images in reflection and double images in transmission, wherein the wedge-angle progression in the second section deviates only less than 0.35 mrad from a wedge-angle progression optimized for preventing ghost images in transmission.

27. The thermoplastic film according to claim 20, wherein, in a transition region between the first section and the second section and/or the second section and the third section, the wedge-angle progression is such that the wedge angle deviates less than 0.2 mrad from a wedge-angle progression optimized for preventing ghost images in transmission.

28. The thermoplastic film according to claim 20, characterized in that the thermoplastic film has at the lower edge a thickness of less than 1 mm, and has a thickness of more than 0.3 mm at the lower end.

29. A laminated glass pane, comprising:
a first glass layer;
a second glass layer; and
a thermoplastic film according to claim 20,
wherein the thermoplastic film is situated between the first glass layer and the second glass layer.

30. The laminated glass pane according to claim 29, wherein the laminated glass pane has a thickness of 1 mm to 8 mm at the lower end.

31. The laminated glass pane according to claim 29, wherein the first glass layer or the second glass layer has a thickness between 1 mm to 3 mm at the lower end.

32. A method for producing a thermoplastic film according to claim 20, wherein a wedge angle required for compensation of a double image is calculated as a function of a local angle of incidence and a local radius of curvature of the laminated glass pane, and a resultant progression of the wedge angle is determined.

33. The method according to claim 32, wherein, at least in the second section the wedge angle required for compensation of ghost images is determined relative to different eye positions and the function of the wedge-angle progression is calculated as a curve fit on a wedge-angle determined therefrom.

34. A method for producing a laminated glass pane, comprising:
obtaining a first glass layer;
obtaining a second glass layer;
placing a thermoplastic film according to claim 20 on the first glass layer;
placing the second glass layer on the thermoplastic film;
bonding the first glass layer to the thermoplastic film; and
bonding the second glass layer to the thermoplastic film.

35. The method for producing a laminated glass pane according to claim 34, wherein a wedge angle required for compensation of a double image is calculated as a function of a local angle of incidence and a local radius of curvature of the laminated glass pane.

36. A head up display arrangement, comprising a projector for illuminating a head-up display region of a laminated glass pane and a laminated glass pane equipped with a thermoplastic film according to claim 20, wherein, during operation, the projector substantially illuminates the second section.

37. A method of using a thermoplastic film, comprising:
bonding a thermoplastic film according to claim 20 within a laminated glass pane; and
installing the laminated glass pane as a windshield for displaying a head-up display in a motor vehicle or as an information display in a building.

38. A method of using of a laminated glass pane, comprising installing a laminated glass pane according claim 29 as windshield for displaying a head-up display in a motor vehicle or as an information display in a building.
